(19) United States
(12) Patent Application Publication
(10) Pub. No.: US 2009/0198693 A1
(43) Pub. Date: Aug. 6, 2009

(54) METHOD AND APPARATUS FOR ORDERING ITEMS WITHIN DATASETS

(76) Inventor: Richard Alexander Stephen Pura, Victoria (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/368,235

(22) Filed: Feb. 9, 2009

Related U.S. Application Data
(63) Continuation-in-part of application No. 11/036,136, filed on Jan. 18, 2005, now abandoned.

(51) Int. Cl. G06F 7/00

(52) U.S. Cl. 707/7; 707/E17.104

(57) ABSTRACT

Methods and apparatus permit displaying items of datasets resulting from executing queries on a database in an order specified by a hierarchy. The hierarchy has a number of categories arranged in an order. Each item is associated with one of the categories. The items in a dataset can be ordered by determining which category each item belongs to and looking up the ordinal position of that category in the hierarchy. A list of categories represented in the dataset may be provided. Items may be classified in two or more hierarchies. A user may be permitted to select one of the hierarchies according to which the items should be sorted. The criteria used to classify the items may be different from the criteria used to query the database to obtain the dataset.

### CROSS-REFERENCE TO RELATED APPLICATION

This application is a continuation-in-part of application Ser. No. 11/036,136 filed on 18 Jan. 2005 which is hereby incorporated herein by reference.

### TECHNICAL FIELD

The invention relates to databases and to computer systems that include search engines which produce sets of items which match search criteria. The invention has particular application to ordering items within datasets of items produced by searches and to displaying search results to users.

### BACKGROUND

There exist search engines which can search through very large databases for records which match search criteria provided to the search engine. Such search engines often sort the items in a resulting dataset by some measure of relevance. An example of such a search engine is the internet search engine operated by Google Inc. A problem encountered by users of such search engines is that the resulting dataset may be very large. This can result in the user being “drowned in data”. The result ranking mechanism used by the search engine may not rank the items of most interest to the user most highly. Users must review large numbers of items belonging to the dataset resulting from a search to locate items of interest. This can be time consuming because typical search engines only present the user with a few items at a time.

One could sort the items of a dataset according to a user-supplied sorting criterion. However, such sorting can be computationally intensive, especially where the dataset is very large. Consequently, permitting users to sort the items of search result datasets according to criteria other than a relevance criterion built into the search system is typically impractical.

There is a need for systems which permit the rapid location and identification of items of interest within large datasets of items representing search results. There is a particular need for such systems which can automatically organize items in the datasets in a desired organizational structure to facilitate this.

### SUMMARY OF THE INVENTION

This invention has a number of aspects. One aspect of the invention provides a method for ordering items in a dataset according to a hierarchy. The method comprises, in a computer system: providing a dataset comprising a plurality of items, each item comprising a key associating the item with a category in a hierarchy comprising a plurality of categories, each of the categories having an ordinal position in the hierarchy; using the keys to look up the ordinal positions of the categories associated with the items; and, sorting the items in an order of the ordinal positions of the corresponding categories.

In some embodiments of the invention, each of the items is associated with a category in each of a plurality of hierarchies and the method comprises: selecting one of the hierarchies as a basis for sorting the items in the dataset; and, subsequently using the keys to look up the categories associated with the items and the ordinal positions in the selected hierarchy of the categories associated with the items.

Each of the items may comprise a plurality of keys. In such cases, one of the plurality of keys may correspond to each of the hierarchies and the method may comprise, for each item, using the one of the plurality of keys corresponding to the selected hierarchy to look up the ordinal positions of the category associated with the item in the selected hierarchy.

Another aspect of the invention provides a program product comprising a medium bearing computer-readable signals. The signals comprise instructions which, when executed by a data processor in a computer system, cause the computer system to execute a method according to the invention.

Another aspect of the invention provides apparatus for providing ordered lists of items. The apparatus comprises a database storing records representing a multitude of items. Each of the items has a plurality of attributes and a unique identifier. Each of the items is associated with one category in a hierarchy. The apparatus includes a search engine disposed to receive and execute user queries to yield datasets of items. Each dataset matches a corresponding one of the user queries. Each dataset comprises at least the unique identifiers for the items of the dataset. The apparatus also comprises a sorting mechanism configured to: receive the dataset; use the unique identifiers from the dataset to look up a predetermined ordinal position of one of the categories of the hierarchy corresponding to each item in the dataset; and, present items from the dataset in an order corresponding to the ordinal positions.

Further aspects of the invention and features of specific embodiments of the invention are described below.

### BRIEF DESCRIPTION OF THE DRAWINGS

In drawings which illustrate non-limiting embodiments of the invention,

FIG. 1 is a block diagram of a system according to an embodiment of the invention;

FIG. 1A is a block diagram of a system according to another embodiment of the invention;

FIG. 2 is a diagram illustrating a structure of an example hierarchy;

FIG. 3 is a block diagram illustrating a data item including keys indicating the location of the data item in a number of hierarchies

FIG. 4 is a flow chart which illustrates an example method of the invention;

FIG. 5 is a diagram illustrating a structure of a hierarchy for use in an example book database;

FIG. 5A is a diagram illustrating a structure of an alternative hierarchy for use in the example book database;

FIG. 6 is a diagram illustrating tables which define a hierarchy in an example book database;

FIG. 6A is a diagram illustrating tables which define a hierarchy in an alternative example book database;

FIG. 7 is a diagram illustrating a book table which contains information about copies of books in an example book database;

FIG. 8 is an example of a table of a type that could be used by a search engine to identify books matching a query in an example embodiment of the invention;

FIG. 9 is an example of a search output list and a list of title groups represented in the search output list for an example embodiment of the invention;

FIG. 10 is an example of a table used by a sorting mechanism in an example embodiment of the invention;

FIG. 11 is an example table produced by a sorting mechanism according to an example embodiment of the invention; and,

FIG. 12 is a example display of sorted results of a search in a book database.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This invention relates to databases and search engines for searching for items of interest in databases.

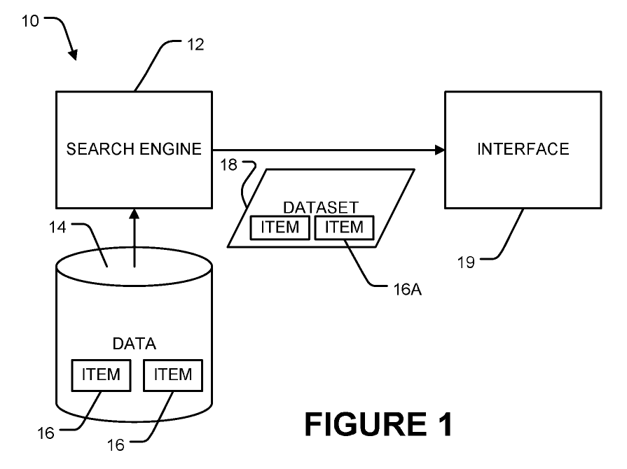

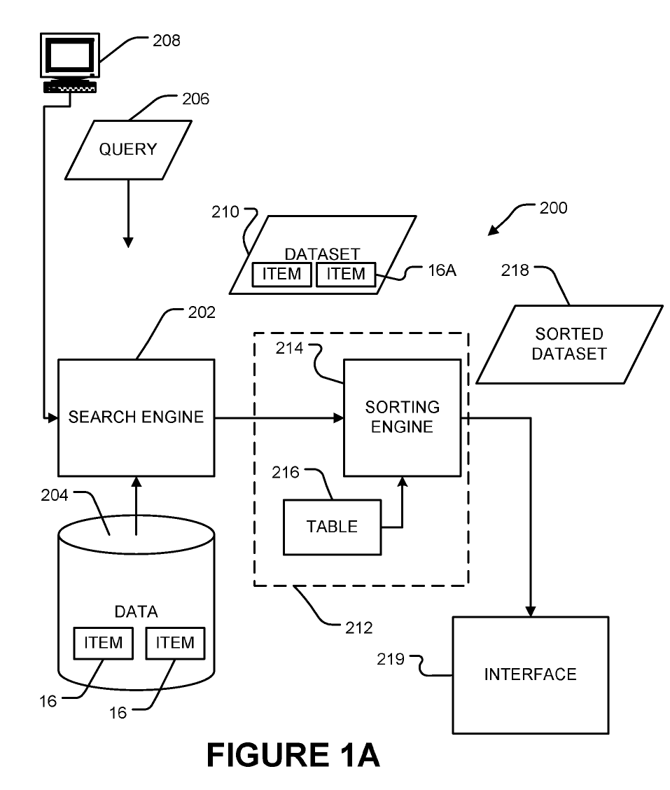

A system 10 according to one embodiment of this invention is depicted in FIG. 1. System 10 comprises a search engine 12 which searches a database 14 for items 16 which match supplied search criteria. Search engine 12 provides a dataset 18 containing items 16A which match the search criteria. System 10 comprises an interface 19 which presents the contents of dataset 18 to a user in an order determined by a predetermined hierarchy.

Interface 19 may take any suitable form. In some embodiments of the invention, interface 19 comprises a computer display. In some embodiments, interface 19 comprises a network interface that forwards the ordered contents of dataset 18 to a user computer by way of a data communication network, such as the internet. Interface 19 may comprise a web server that generates web pages which include representations of items in dataset 18 and forwards those web pages to a web client, such as Microsoft™ Internet Explorer.

Search engine 12 typically comprises software executing on a suitable data processor. The data processor may have any suitable architecture. The data processor may comprise, for example, one or more computers each having one or more processors.

Database 14 may comprise a single repository of data or may be distributed across multiple locations. Database 14 may be organized internally in any suitable manner. For example, database 14 may comprise a relational database. Database 14 may support any suitable language for specifying a query. For example, database 14 may be a SQL (Structured Query Language) database. Database 14 may comprise commercially-available database software such as Oracle™ available from Oracle Corporation of Redwood Shores, Calif. or DB2™ available from IBM corporation of White Plains, N.Y. The software may run on any suitable computer system. Database 14 may contain records representing thousands, millions, or more of items 16.

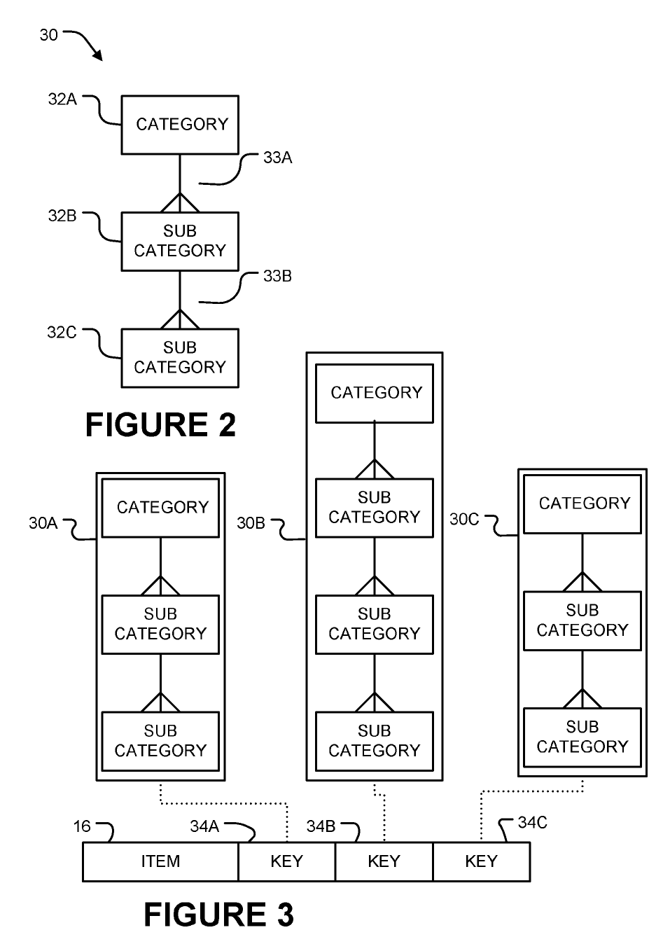

A hierarchy is an ordered set of categories. Each category can contain items 16 and/or other categories. Each item 16 in database 14 is assigned a position in at least one hierarchy. Each item 16 may be assigned positions in two or more hierarchies. Each hierarchy has a number, n, of levels. Where there are multiple hierarchies the hierarchies may each have different numbers of levels or the same number of levels. An example of a hierarchy 30 is shown in FIG. 2. Hierarchy 30 has n=3. Hierarchy 30 has a number of categories 32A. Categories 32A have a predetermined order. Each category 32A has a number of sub-categories 32B. Each sub-category has a number of sub-categories 32C. Connectors 33A indicate that each category 32A may have multiple sub-categories 32B. Connectors 33B indicate that each sub category 32B may have multiple sub categories 32C.

As shown in FIG. 3, each item 16 includes one or more keys 34. Each key 34 indicates the location of the item 16 in one or more hierarchies. The illustrated embodiment has three keys 34A, 34B, and 34C, (collectively keys 34) which indicate the location of item 16 in each of three different hierarchies 30. Each key 34 may comprise, for example, a set of bits in a field of a record corresponding to an item 16 in database 14. The bits contain information indicating the location of item 16 in the hierarchy corresponding to the key 34. Keys 34 are applied to items 16 prior to conducting the search that yields dataset 18. Keys 34 are used to order the items in a dataset for presentation to a user in an order determined by a corresponding hierarchy.

Some embodiments of the invention (for example, the embodiment illustrated in FIG. 1) perform sorting of datasets containing search results within a specialized search engine. Systems according to preferred embodiments of the invention are structured like example system 200 of FIG. 1A. System 200 features a search engine 202 which searches a database 204 for items matching a query 206 supplied from a user computer 208. Search engine 202 and database 204 may be any suitable database including, for example, any of various suitable commercially available databases and/or search engines. The invention may be applied in cases where the search engine is not integrated with the database. For example, database 204 may comprise a database maintained by suitable SQL database software (a wide range of such software is available) coupled with a search engine that manages queries of the database.

Each item 16 in database 204 has a unique identifier. The unique identifier is sometimes called a “primary key”. Search engine 202 produces a dataset 210 in response to the query. Dataset 210 includes a list of the unique identifiers of each item 216A in database 204 that matches query 206.

Dataset 210 is provided to a sub-system 212 that puts items 216A in order according to the hierarchy. Subsystem 212 comprises a mechanism 214 that relates the unique identifiers of items 16A in dataset 210 to positions in a hierarchy. Subsystem 212 may comprise a second database and search engine or a second search engine that accesses database 204. Sub-system 212 may operate completely independently of search engine 202.

In some embodiments of the invention, database 204 is configured to use a searchID for each item as the unique identifier for each item. In such embodiments, subsystem 212 may comprise a table 216 which relates searchID values (or values derived from searchID values) to the order specified by the hierarchy. Subsystem 212 can then use table 216 to obtain an order for each item 16A and then sort the items 16A into a sorted dataset 218 according to the order. Sorted dataset 218 may be returned to computer 208 for display or, more generally, provided to an interface 219 which permits details regarding items in sorted dataset 218 to be displayed, printed, forwarded to computer 208 or another computer system, saved, or the like, in order in any suitable way.

Subsystem 212 preferably returns information associated with the hierarchical categories into which items 16 are classified in addition to a list of items 16 in hierarchical order. For example, where subsystem 212 is used to return a list of books which are categorized in a hierarchy by the authors and titles of the books then subsystem 212 may return a list of authors and titles corresponding to the books in a dataset. Subsystem 212 may keep the information associated with the categories of a hierarchy (author/title information in this example). In this case, subsystem 212 can supply the information associated with the categories without the need to retrieve that information from database 204. This can reduce the load on database 204 and search engine 202.

Because, items 16 are retrieved in hierarchical order, sorting of items 16 can be minimized. In some cases, subsystem 212 retrieves items 16 which will be presented serially. In such cases, subsystem 212 can reduce the amount of sorting performed by initially retrieving and sorting only enough categories to provide enough items 16 for initial purposes. For example, where subsystem 212 is presenting items to be displayed on a display a few items at a time, it will typically be sufficient for subsystem 212 to initially retrieve and sort items 16 belonging to the first 100 categories or so to be included in sorted dataset 218. In this manner, only a subset of the dataset 218 needs to be sorted at one time.

For example, consider a case where a user searches a database of books for books on the subject of “ecology”. The database may contain records for 100,000 individual books which match this query. Those books may include books having 10,000 different titles by 1000 different authors. Since a few hundred books at most can be displayed to a user at one time, subsystem 212 may initially return a sorted list of the first 100 authors and the first 100 or so books. The user can scroll down through the dataset as they desire. However, this technique avoids the need to sort the full dataset 218 at once before displaying the first part of the search results.

The apparatus shown in FIG. 1A permits any suitable search engine to be used to store and retrieve data about individual items while allowing a user to obtain resulting datasets sorted in a manner that facilitates identification of items of most interest to the user. This can be done without imposing additional computational demands on search engine 202.

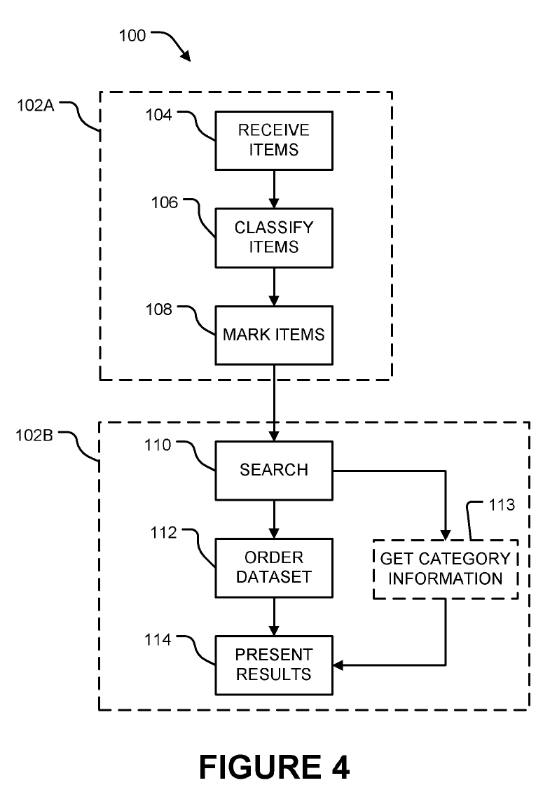

A method 100 according to the invention is shown in FIG. 4. Method 100 involves preparation phase 102A and a searching phase 102B. In block 104, method 100 receives items 16. Items 16 may already be present in database 14. In block 106, method 100 classifies each item 16. Classifying involves assigning each item 16 as belonging to a category and one or more sub categories, where applicable, within a hierarchy. Classifying identifies a location for each item 16 in each of one or more hierarchies. Classifying may involve applying a set of criteria of arbitrary complexity to identify the category to which each item belongs. Since classifying can be performed in advance, it is not necessary that the classification criteria be simple enough to be performed conveniently in real-time as part of performing a search.

In block 108, each item 16 is marked to indicate its location in the one or more hierarchies. Marking an item 16 may comprise associating a key 34 with item 16. Key 34 directly or indirectly contains information indicating the location of the item 16 in the hierarchy. Key 34 may be stored in database 14, for example, in a field in a record for each item 16 or in a separate table of keys 34. It is sufficient if a system according to the invention is able to retrieve a key 34 for each item 16A represented in a result set 18.

The location of items 16 in the hierarchy specify the order in which items 16 should be displayed. As noted above, each item may be classified in multiple hierarchies. Where each item is classified in a plurality of hierarchies, items 16A in a result set 18 may be presented in any of several different orders by selecting one of the hierarchies to be used in ordering the items 16A.

Search phase 102B begins by performing a search (block 110) of database 14 to yield a result set 18 identifying selected items 16A. Block 110 may be performed through the use of any suitable searching methods. The search may select items 16A based upon any attribute or combination of attributes of the items. The attribute(s) used to select items 16A from items 16 may be chosen independently of the attributes used to determine the category to which each item 16 belongs.

In block 112 the items 16A in result set 18 are ordered according to their locations in a hierarchy. Block 112 involves using keys 34 allocated in preparation phase 102A to determine an order for presentation of the items 16A in result set 18. In some embodiments, block 112 involves both ordering items 16A in order of the ordinal position corresponding to the category to which each of items 16A belongs and then ordering any of items 16A which belong to the same category according to a sort criterion.

Block 113 gets category information for the categories to which items 16A belong. The category information may be presented to a user separately from the information about individual items 16A. For example, the system may present both a list of categories represented in result set 18 as well as a list of items within an initially-selected one of the categories.

In block 114 items 16A are presented to a user in the order determined in block 112. Block 114 may involve displaying representations of the items on a display, printing a list of the items, storing an ordered list of the items, or the like. In some embodiments block 114 comprises segregating from one another or otherwise identifying to a user groups of items 16A which belong to the same category. In some embodiments, block 114 comprises displaying both all or a portion of the list of the categories represented in result set 18 as well as all or a portion of the list of items within an initially-selected one of the categories. The display may comprise separate scrollable lists of items and categories. The scrollable list of categories may be used as an index of the list of items.

Preparation phase 102A may be performed asynchronously with search phase 102B. Preferably, preparation phase 102A is performed as soon as practical after any new item(s) 16 are added to database 14. Preparation phase 102A may be performed at regular intervals or may be triggered manually or automatically by, for example, the addition of items 16 to database 14.

Ideally, the key 34 corresponding to each item 16 is unique and can be conveniently associated with a category in the corresponding hierarchy to which the item 16 belongs. One way to do this is to construct the key 34 by concatenating an ID for the category to which the item belongs with a unique number, such as a sequence number.

In situations where the length of keys 34 is limited, there is a tradeoff between the number of distinct categories that may be represented in the database and the number of items can be stored in the database for each category. For example, consider the case where a signed 32 bit integer is used as key 34. Such an integer has 31 value bits. Of these, if 7 bits are reserved for a sequence number, then 24 bits are available for identifying different categories. This permits storing items belonging to any of 224 (about 16 million) categories. However, such a structure provides sequence numbers for only 27 (128) items for each category. This may be unduly limiting since the database may need to store more than 128 items in some categories. The number of bits allocated to the sequence number could be increased to permit more unique sequence numbers for identifying items with each category. However, this would dramatically reduce the number of categories capable of being represented by the key 34. For example, if 10 bits were assigned to the sequence number part of key 34 to provide 2¹⁰=1024 distinct sequence numbers then only 21 bits would be available for identifying categories. Thus the number of categories would be reduced to only 2²¹ (about 2 million).

One way to address this issue is to use a larger key 34. For example, a 64 bit key 34 is large enough to have a first part capable of identifying any of 2²⁴ categories and still have enough bits for a second part capable of identifying up to 2³⁹ items in each category. Key 34 could be made up of two or more separate parts. For example, a key 34 could comprise a 32-bit integer value representing a category to which an item belongs and a second 32-bit integer value representing a sequence number of the item within a category.

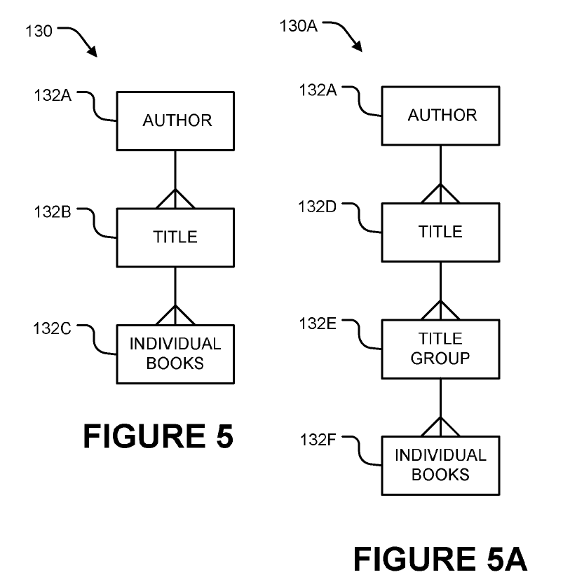

An alternative way to deal with a small key 34 is to classify items into category groups, as shown, for example, in the specific example illustrated by FIG. 5A. In such embodiments of the invention, the first part of key 34 identifies a category group. Where key 34 is a 32-bit signed integer then, for example, 24 bits may be set aside to identify different category groups. 7 bits may be used as a sequence number within each category group. Each category group is associated with one category. Each category is associated with one or more category groups. Since multiple category groups may be associated with one category it is possible to have more than 128 items associated with any category.

In some embodiments a reference/sequence (R/S) system is used for tracking ordinal positions of items. The references, R, may be sequential numbers corresponding to ordinal positions of items after a search engine data has been freshly reloaded. The references assigned to items may be spaced apart from one another to leave intervening references available for allocation to subsequently added items. For example, the references may initially be spaced by some number such as 8 in order to allow room for additional entries to be added.

New items that should be ordered between two consecutively-ordered existing items may be assigned a reference half-way between the references for the existing items. Thus if, for example, a new item is to be ordered between two existing items to which the references 16 and 24 have been allocated (indicated as R16 and R24), the new item may be assigned the reference 20, midway between R16 and R24. With this addition the items are ordered: R8, R16, R20, R24, R32 . . . .

Where a new item is to be inserted between two existing items having consecutive references (e.g. R33 and R34) then a sequence numbering scheme may be used to keep track of the orders of the items. In such a scheme, each reference has an accompanying sequence number. A sequence number having a default value may be assigned to each item when the search engine data is freshly reloaded. This default sequence number may be implied and does not need to be stored. For example, the sequence number may have a value in the range of 0 or 1 to some large number such as 4,000,000,000. In some embodiments, the default sequence number is roughly in the middle of this range to permit insertions of items that should be ordered before or after the existing items.

When it is necessary to insert a new item having an ordinal position between two consecutive references (such as between R17 and R18) one may insert a cross-reference ID number (Xref Id Number) in place of the reference number for the item. The Xref ID number is recognizable as being distinct from a reference number, for example, by its value. Xref records may be stored separately, for example in one or more tables and contain pairs of reference/sequence numbers where the sequence numbers have values other than the default value. The presence of a Xref ID number in place of a reference number for an item is an indication to the search engine that it should use the Xref ID number to look up the Xref in order to get R/S values for the item.

To insert a new item having a position between the items associated with R17 and R18 then, one could apply the XRef ID X1 to the item. The order for the items would then be given by:: R8, R16, R17, X1, R18, R19, R20, R24, R32 . . . . In this example, X1 is a pointer to an entry in the Xref table that has the general structure shown in the following Table:

| Xref ID | Ref | Seq |
|---|---|---|
| X1 | R17 | S3000000000 |

An advantage of this arrangement is that existing references do not need to be changed in order to add new items, at least not till the search engine data is freshly reloaded, a relatively infrequent occurrence. Also, Xref entries can be conveniently renumbered within the Xref Table without affecting other search engine data. In the above example, if any series of sequence numbers in the Xref Table becomes filled then all or a portion of the sequence numbers in the Xref Table may be reassigned in a way that preserves the order of the sequence numbers assigned to items but leaves intermediate sequence numbers to be assigned to new items.

The use of keys, reference numbers and/or sequence numbers which directly indicate a relative sequence of items facilitates permitting jumps to portions of a dataset corresponding to specific points in a hierarchy. For example, consider the case where a user wishes to search a list of street addresses for those on “Main Street”. The items in the list are associated with reference/sequence numbers or keys that directly indicate the relative order of the items when arranged in alphabetical order by street name. The user may wish to jump to those names in the results that start with the letter “M”.

To facilitate this, a table may be constructed that associates ranges of values for the reference/sequence numbers, keys or the like that specify the ordinal positions of the items with different sections of a hierarchy—in this case street names beginning with certain letters of the alphabet. For example, the table may be called AlphabetRef Each entry in the AlphabetRef table contains a starting point—in this example, a single letter such as “m”—and the R/S pair (or index value) of the first entry in the search data that begins with the starting point. An AlphabetRef table may, for example, have a structure as shown in the following Table:

| AlphabetRef-Value | R/S values |
|---|---|
| A | R1/S2G |
| B | R99/S2G |
| C | R543/S3G |
| . . . | . . . |
| M | R2433/S2G |
| . . . | . . . |

Because an R/S pair (or other key) is pre-assigned to every item, results can be readily retrieved in R/S order starting at any point. The AlphabetRef table may be used to determine a starting point for a search corresponding to, in our example, the letter “M”.

The invention is not limited to databases of any particular subject. An example embodiment of the invention which permits users to search for books in a database of available books will now be described. Consider the problem of providing a database to track used books available for purchase. Each book has an author, a title and may pertain to a particular subject. Within an author/title, each available copy of a used book is different. The different individual copies may be in different conditions, have different prices, be offered by different vendors, and be in different locations.

FIG. 5 shows a hierarchy 130 into which used books may be classified. Hierarchy 130 groups individual books together based upon the author and title of the books. FIG. 5 indicates that books in a dataset should be ordered first by author (for example, in alphabetical order by author), and within each author by title (for example alphabetically). FIG. 5A shows an alternative hierarchy structure in which books are classified into category groups, as described above. In this example, the category groups are called “title groups”.

Items relating to individual copies of books are entered into database 14. In this case, each item 16 might include the following information about the copy of the book:

Author;

Title;

Edition;

Type (e.g. hard cover or paperback);

Publisher;

Condition;

Pages;

Vendor;

Location;

Price;

etc.

After a number of items 16 each representing a distinct copy of a book are present in database 14, the items may be classified. In this example, classifying items 16 involves assigning an ordinal position to each distinct combination of author/title represented by items 16 in database 14. While the ordinal positions could be sequential, it is preferable to leave space between the ordinal positions to permit the insertion of new author/title combinations for books that may be subsequently added to database 14 without requiring the ordinal positions of any (or at least not many) other author/title combinations to be changed.

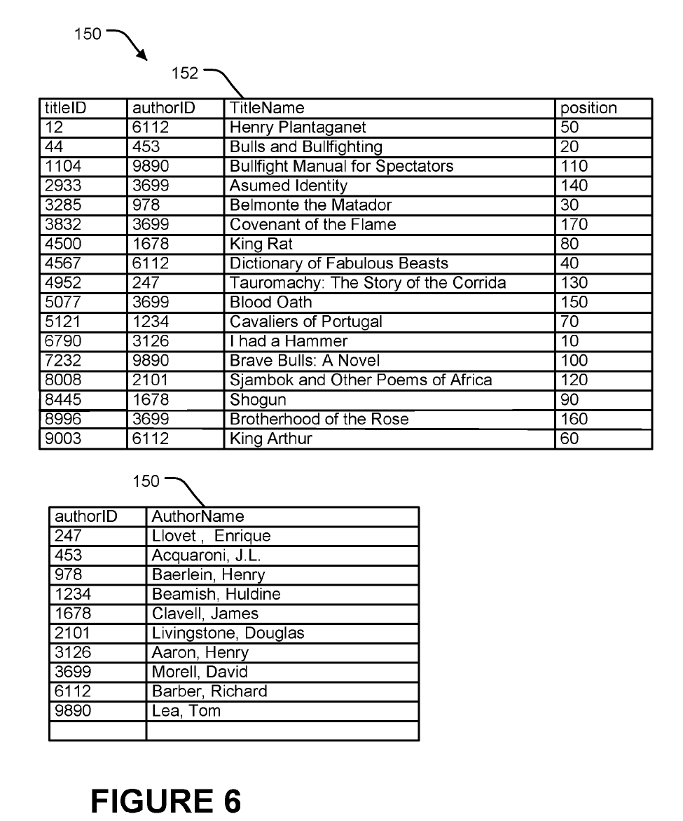

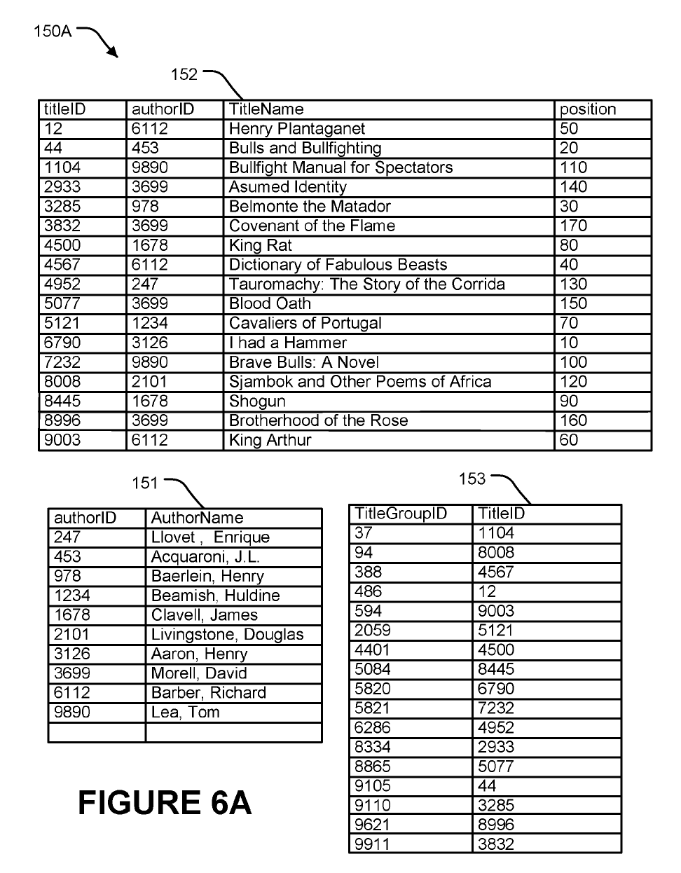

A hierarchy may be defined by providing appropriate database tables. FIG. 6 shows a set 150 of tables 151, and 152 which define a hierarchy in an example book database. Author table 151 contains names of authors. Each author name is associated with an authorID. Title table 152 contains titles in the database. Each row of title table 152 corresponds to a unique author/title combination. Each row includes a titleID field containing a value corresponding to that title and an authorID which associates the title with one of the authors from author table 151. Each row of table 152 also includes a position value indicating the ordinal position in the hierarchy of the author/title corresponding to the row.

FIG. 6A shows a set of tables 150A which define a hierarchy in an alternative book database in which books are classified into title groups with each title group corresponding to an author/title combination. Two or more title groups may correspond to the same author/title combination. FIG. 6A includes tables 151 and 152 as well as an additional titleGroup table 153 that relates titleGroupIDs, which identify individual title groups, to titleIDs, which identify individual author/title combinations.

It can be appreciated that there may be a number of individual book copies which share an author/title combination. For example, a database may include five items 16 corresponding to five distinct copies of Brian Greene's excellent book The Elegant Universe: Superstrings, Hidden Dimensions, and the Quest for the Ultimate Theory. Classifying items 16 may also comprise assigning a number to each individual item belonging to an author-title combination such that the combination of the ordinal position of the author/title combination and the number assigned to the individual item 16 is unique. For example, a sequence number may be assigned to each item 16 within an author/title combination or within a title group.

In the following example, each item 16 is assigned a number made up of a first part directly or indirectly indicating the ordinal position of the author-title combination to which the item 16 belongs and a second part consisting of a sequence number. This sequence number may be associated with the item 16 as a key 34. Key 34 may be called a “SearchID”.

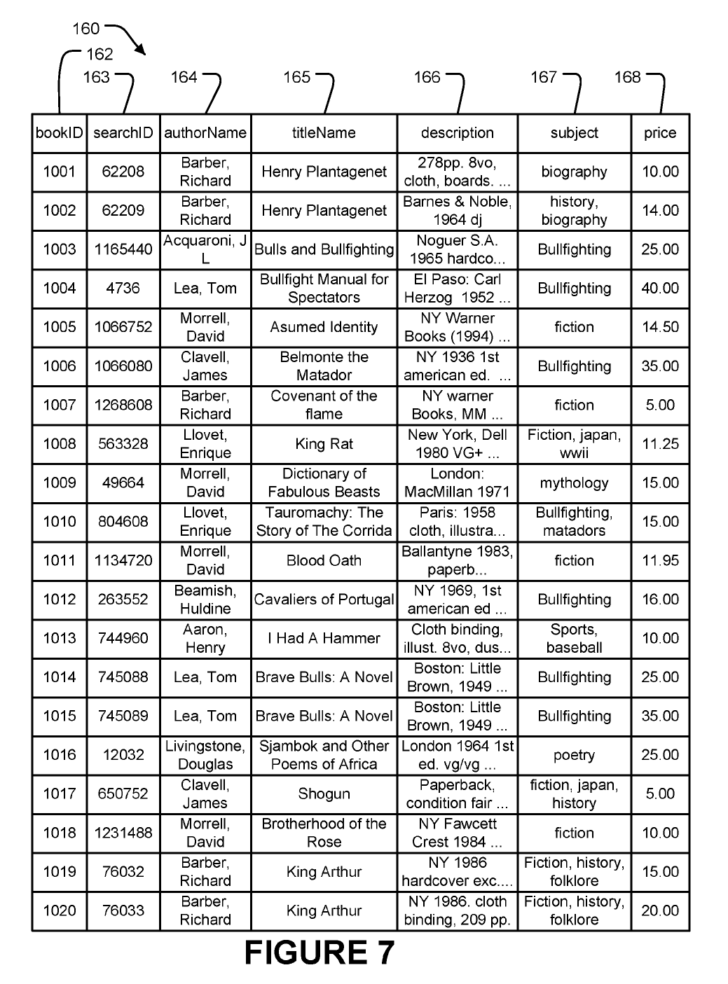

FIG. 7 illustrates a possible book table 160. Book table 160 includes:
a bookID column 162 containing bookID values unique to each book represented in database 14;
a searchID column 163 containing a searchID value for each book;
an authorName column 164 containing the name of the author of each book;
a titleName column 165 containing a title for each book;
a description column 166 containing a description of the book;
a subject column 167 containing keywords identifying the subject matter of each book;
and a price column 168 containing a price for each book.

The values in the titleName column of table 160 do not need to be identical to the title in title table 152. For example, titleName column 165 may contain the title of a book as originally entered by a bookseller. Even if that title contains typographical errors it can be preserved in table 160. Title table 152 may contain titles standardized for use by system 200.

The searchID may, for example, be a 32-bit signed integer value. In an example embodiment 7 bits are allocated for a sequence number and 24 bits are allocated to identify a title group. In this scheme, a book belonging to a title group having a titleGroupID of 1234567 (binary 100101101011010000111) may have a searchID in the range of 158024576 (binary 1001011010110100001110000000) to 158024703 (binary 1001011010110100001111111111) inclusive. In this example, the first book attached to the title group having a titleGroupID value of 1234567 would have a searchID value of 158024576, the next book attached to this title group would have a searchID value of 158024577, and so on. After 128 books have been attached to this title group, the title group is “full”. A new title group could then be created and associated with the author/title combination to hold additional books of the same author/title combination.

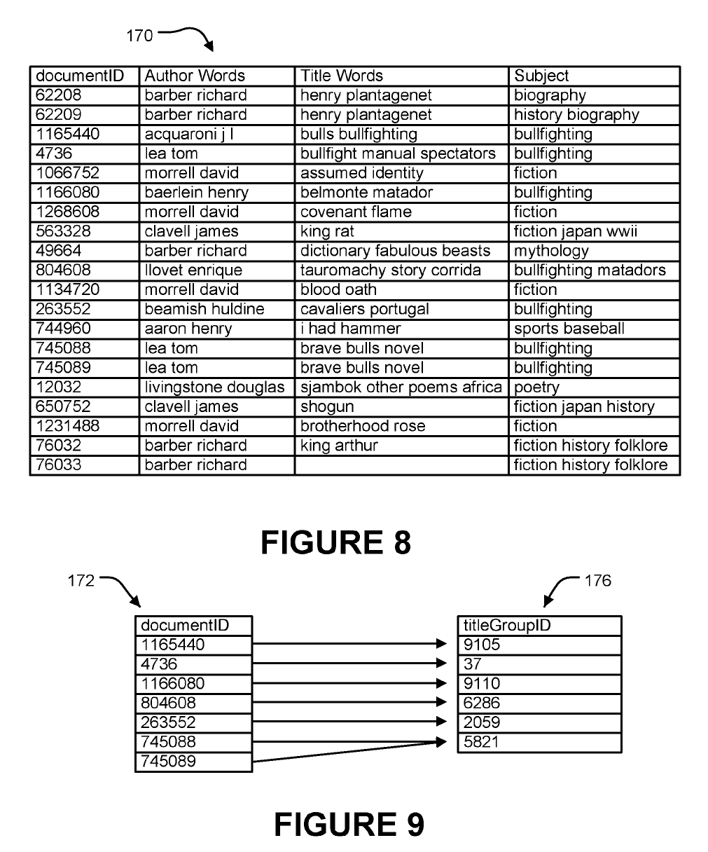

Data for each book is made available to search engine 12. This may be done by loading into a memory used by search engine 12 data representing all or selected information about each item 16. FIG. 8 is an example of information 170 is made available to search engine 12 in one embodiment of the invention. Data 170 includes a documentID value for each book to be covered by the search engine. In preferred embodiments of the invention the documentID is the same as the searchID to be used in ordering search results. Data 170 also includes important words from the author, title and subject of each book.

Details of the internal mechanisms used by search engine 12 to locate items in a result dataset matching a query are not important to this invention. All that is required is that search engine 12 produces a dataset containing references to items 16A (records relating to books in this example) that match a search criterion. Search engine 12, may, for example, produce a list of matching items each identified by the corresponding documentID value from data 170. For example, FIG. 9 shows a possible search output list 172 from search engine 12 representing the results of a search in data 170 for books having a subject that includes “bullfighting”.

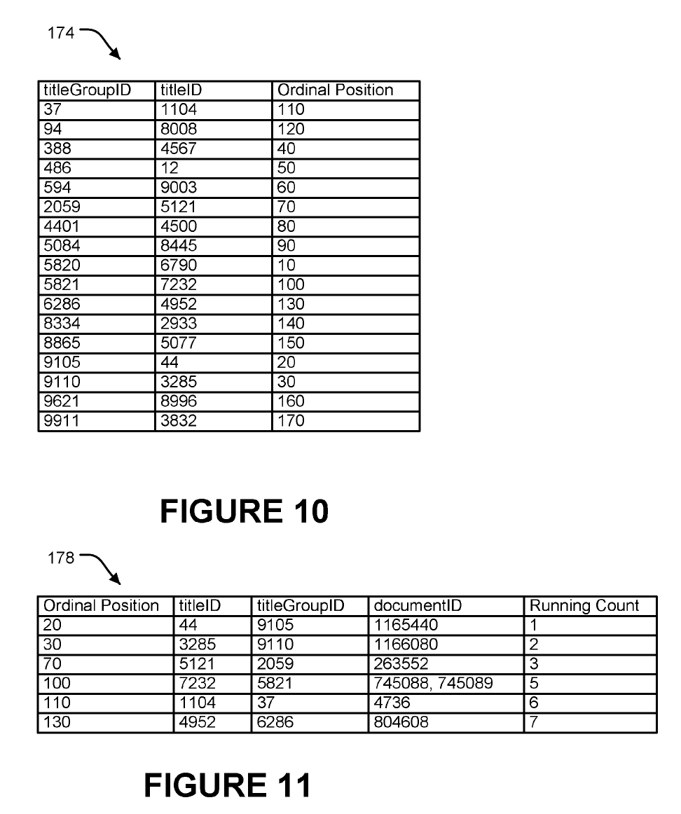

A sorting mechanism according to one embodiment of the invention uses a table 174 as shown in FIG. 10 to identify the title group corresponding to each item in search output list 172. Table 174 is preferably resident in memory so that it can be accessed quickly. Table 174 could be stored in any suitable computer-readable medium. Table 174 has one row for every title group. For example, in a case where there are 500,000 title groups, table 174 would have 500,000 rows.

Upon receiving search output dataset 172 the sorting mechanism identifies the title group with which each item in search output list 172 is associated. The sorting mechanism then determines the order in which the title groups should be presented according to the ordinal position of each title group in the relevant hierarchy. The sorting mechanism may also provide a list of categories represented in search output dataset 172.

In an example embodiment of the invention, the sorting mechanism determines the title group by inspection of the documentID values listed in search output list 172. Where the documentID values are 32-bit signed integers having the 7 lowest-order bits reserved for use as a sequence number and the 24 highest-order bits reserved for a titleGroupID value then the titleGroupID value for each item referred to in search output list 172 can be obtained by right-shifting each of the documentID values in search output list 172 by 7 bits.

The unique titleGroupIDs corresponding to items in search output list 172 may be stored in a table 176 as shown in FIG. 9. To avoid later processing it may be desirable to save information identifying the title group corresponding to each documentID value in addition to storing the unique titleGroupID values in table 176.

The sorting mechanism can use table 150A (FIG. 6A) to determine the titles corresponding to the title groups listed in table 176. This can be performed, for example, using the SQL query:

### SELECT . . . .

FROM titleGroup, title
WHERE titleGroup.titleID=title.titleID
AND titleGroup.titleID IN (value1, value2 . . . )
ORDER BY ordinalPosition.

The sorting mechanism can cross-reference the documentID values (which represent books matching the search) to the titleGroupID values and their corresponding ordinal positions to determine which books to display. For example, if the system is configured to display 10 books to a user at a time, the sorting mechanism identifies the first 10 books to display and provides information about those first 10 books to interface 19 for display. In preferred embodiments of the invention, the system also identifies categories represented in the search output dataset and provides information about the first few categories to interface 19 for display.

Identifying which books to display may be done by combining information from tables 172, 174 and 176 to yield a table such as table 178 shown in FIG. 11. Table 178 identifies the order in which items representing individual books should be presented. Table 178 can be used to look up only as many books as are needed for presentation at one time. For example, if a display is configured to display records relating to a maximum of 20 books at a time then the system may select the first 20 items to be presented using table 178. In general, it is advantageous to identify a somewhat larger number of items than are to be displayed. For example, the system may be configured to identify the next 100 items to be displayed and then display the first 20 of those items.

As the user indicates a desire to scroll or page to see other items from the dataset the appropriate items to be displayed can be identified using table 178. Any suitable methods for identifying which items from an ordered list to display based upon scroll and/or page commands supplied by a user including the variety of such methods which are known to those skilled in the art and may be applied.

Where the display includes a list of the categories represented in the search result dataset, identifying which categories to display may comprise using table 178 to identify the next set of unique GroupID values. For example, if a display is configured to display information relating to a maximum of 12 categories at a time then the system may select the first 12 unique GroupID values from table 178 to display. Scrolling through a list of categories may be performed in substantially the same manner as scrolling through a list of items.

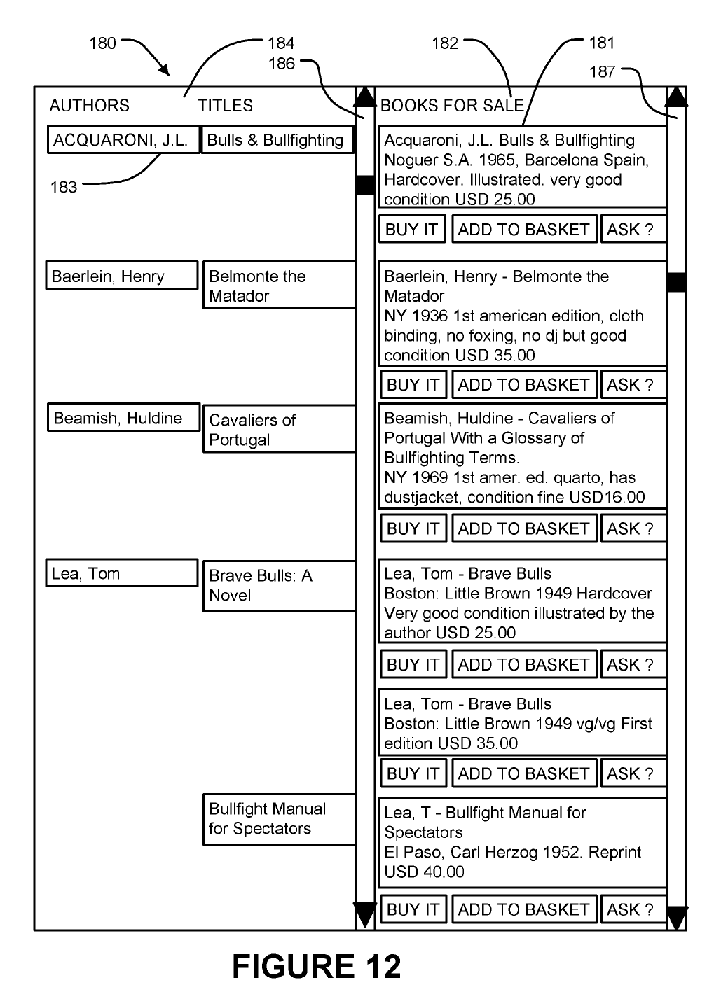

The final result may be presented to a user in any suitable manner. For example, FIG. 12 shows an example display 180 showing the results of a search for books on the subject of bullfighting sorted by author/title/price. Such a search may have been performed on a database containing items representing millions of books. The search may result in a dataset which itself includes a great many items. It can be seen that the example display 180 presents the search results to a user in a logical way. Items 181 representing individual books are presented in a window 182. Authors and titles are displayed in a second window 184. The user can use a first scroll bar 186 to quickly locate an author/title combination of interest and then use second scroll bar 187 to find a particular book of interest within a selected author/title combination. Books are sorted by price within each author/title combination in window 182.

In preferred embodiments of the invention, selecting a category in a displayed list of categories repositions the list of items to show items in the selected category. For example, if a search of the example book database provides a search result dataset including books of 37 different author/title combinations then the system may permit a user to scroll down the list of author/title combinations, select one of the author/title combinations, for example by clicking a pointing device while a cursor controlled by the pointing device is in a position corresponding to the selected author/title combination. Upon selection of the author/title combination, the system automatically positions the list of individual books so that the display displays the individual books belonging to the selected author/title combination (and, possibly, also books belonging to author/title combinations that are adjacent or close neighbors in the hierarchy to the selected author/title combination).

Instead of or in addition to displaying the sorted dataset in a display, a system according to the invention may otherwise present the sorted dataset, for example, by printing the sorted dataset, saving the sorted dataset in a file, or the like.

In some applications, items 16 cannot all be relied upon to have been entered in the identical format. For example, in a large database of books, the same author could be referred to in a number of non-identical ways. For example, James Michener might be listed as “Michener, James” in some items 16, “Michener, J.” in others, “Michener, J. A.”, in others and “Michener, James A.” in others. A system according to the invention may optionally perform cleanup of dirty data as part of the process of determining which books from a dataset to present to a user.

For example, the system could perform a consolidation process on a list of categories represented in a search result dataset. The consolidation process identifies any categories that likely belong together. For example, if the system includes separate categories naming the author as “Michener, James”, “Michener, J.”, “Michener, J. A.”, and “Michener, James A.” then the system could combine all of these categories in their simplest form “Michener, J.” Where this is done, books listed in the system as having been authored under the variants of James Michener's name will all be presented in the same place in the results presented to the user. Where the system performs a tertiary sort on the results according to a feature such as price, the tertiary sort may be performed on the combined results of any consolidated categories so that the user needs to review only one list to find a book in which the user is most interested.

For example, the consolidation process may comprise performing a prefix-matching process on the author names of the title groups referenced in table 176. The prefix-matching process could identify similar author names to be consolidated together. Thus the system could present books stored in the system under any variants of an author's name as all having the same author.

A system according to the invention may comprise a data structure indicating which categories are to be consolidated with one another. This data structure may be created by the application of an algorithm that attempts to identify categories associated with “similar” information (such as author names having common prefixes). The data structure may be created manually or be partly created by the application of automatic processes and then fine tuned manually.

A tertiary sort (e.g. a sort by price) may be performed as part of the process of using table 178 to determine which books to present to a user. Such a sort could be performed on all of the contents of table 178. However, it is typically more efficient to sort only that group of items that could be displayed on the current display. To accomplish this, one can create a subset of items 16A which includes all of those items 16A selected, as above, for the current display and also includes all items 16A in the same category (e.g. the same author-title combination) as the last selected item 16A. The resulting set can be sorted by price or some other tertiary sort criterion using, for example, SQL commands.

As with any large database, it is necessary to carefully maintain the data used in embodiments of the invention. For example, the ordinal title table 174 of FIG. 10 may reside in memory. Changes to table 174 may be required on an ongoing basis as items belonging to new categories (e.g. author/title combinations) are added to the system. In general, it is desirable to keep table 174 as up-to-date as practical in real time. Any suitable maintenance techniques such as swapping in an updated copy of table 174 from a RAM disk, updating table 174 in response to database triggers, timestamp monitoring techniques etc. may be used to maintain table 174.

In the foregoing discussion it has been assumed that each category in a hierarchy has an ordinal position which is different from the ordinal positions of all other categories in the hierarchy. Certainly this is desirable. In some cases, a situation may arise wherein two or more categories in a hierarchy have been assigned the same ordinal position. This could occur, for example, if an update is imperfectly executed or if it is desired to add a category that should fit between two existing categories having contiguous ordinal positions and there is some reason why it is not currently desirable to reassign ordinal positions to the existing categories.

A system according to the invention can be made robust against occasional duplicated ordinal positions by sorting items both according to an attribute used in classifying the items as well as the ordinal position of the category. For example, in the book database described above, Table 150A could be used by the sorting mechanism using the SQL query:

### SELECT . . . .

FROM titleGroup, title
WHERE titleGroup.titleID=title.titleID
AND titleGroup.titleID IN (value1, value2 . . . )
ORDER BY ordinalPosition, titleName.
In this SQL query, the inclusion of titleName in the argument of the ORDER BY Command ensures that items will be ordered correctly even if two title groups share the same value for the ordinal position.

Some embodiments of the invention permit search results to be merged with search results from one or more other sources. Such embodiments of the invention receive search results from the one or more other sources and classify the search results. In general, the search results from the other sources comprise lists of items, which may be called “external items”. In typical cases the other sources may produce relatively few external items and so classifying those items in real time does not involve excessive overhead. Preferably the external items are classified according to the same hierarchy being used to order the items in the search results dataset. After the external items have been classified then they can be inserted at appropriate locations (as determined by the ordinal positions of their categories) in the sorted search results.

For example, consider the case where a system produces a list of books matching a search criterion. There exist various book databases that are searchable by way of the internet. The system could additionally conduct searches of one or more such external book databases. Perhaps each such external book database will return records relating to a small number, for example 10 to 500, books. The system could be configured to parse the data from the external book database(s) and merge that data with a list of books produced by the system. The merge could be performed prior to conducting any tertiary sort so that books from the external database(s) can be sorted together with books from database 204.

In some embodiments of the invention the external items may include items associated with categories that are not represented in the sorted search results. In this case an additional category may be inserted into the sorted search results.

Certain implementations of the invention comprise computer processors which execute software instructions which cause the processors to perform a method of the invention. For example, one or more processors in a computer system may implement the methods of FIG. 4 by executing software instructions in a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The software instructions may be in an encrypted and/or compressed format.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

As will be apparent to those skilled in the art in the light of the foregoing disclosure, many alterations and modifications are possible in the practice of this invention without departing from the spirit or scope thereof. For example:
Instead of using titleGroupID values (more-generally sub-category ID values) to index into table 174 one could use a function thereof (for example, a hash function) or another value containing equivalent information to index into table 174. Depending upon the distribution of titleGroupId values represented in table 174 such alternatives could be more efficient of memory and faster to search than the simple embodiment which is illustrated.
   Accordingly, the scope of the invention is to be construed in accordance with the substance defined by the following claims.

What is claimed is:

1. A method for retrieving information from a database as an ordered dataset according to a hierarchy, the method comprising, in a computer system:
executing a search query on the database and retrieving items of a result dataset in order according to categories assigned to the items, each item comprising a key associating the item with a corresponding category in a hierarchy comprising a plurality of categories, each of the categories having a predetermined ordinal position in the hierarchy;
arranging the items of the dataset in an order of the ordinal positions of the corresponding categories; and,
presenting the dataset in the order by one or more of: displaying; printing; forwarding to another computer system; and storing in a memory; at least a portion of the sorted dataset.

2. A method according to claim 1 wherein each of the items is associated with a category in each of a plurality of hierarchies, each of the categories has a predetermined ordinal position in the corresponding one of the hierarchies and the method comprises:
selecting one of the hierarchies as a basis for arranging the items in the dataset; and,
subsequently using the keys to look up the categories associated with the items in the selected hierarchy and the corresponding ordinal positions in the selected hierarchy of the categories associated with the items.

3. A method according to claim 2 wherein each of the items comprises a plurality of keys, one of the plurality of keys corresponding to each of the hierarchies and the method comprises, for each item, using the one of the plurality of keys corresponding to the selected hierarchy to look up the ordinal positions of the category associated with the item in the selected hierarchy.

4. A method according to claim 1 comprising using the keys to retrieve and assemble a list of categories of items in the dataset.

5. A method according to claim 4 comprising sorting the list of categories in order of the ordinal positions of the categories in the list.

6. A method according to claim 5 wherein the list of categories comprises descriptive information for each of the categories in the list.

7. A method according to claim 6 wherein providing the dataset comprises running a query against a first database containing records representing a multitude of items.

8. A method according to claim 1 wherein providing the dataset comprises running a query against a first database containing records representing a multitude of items.

9. A method according to claim 8 wherein using the keys to look up the ordinal positions of the categories associated with the items comprises using the keys to query a second database for the ordinal positions and arranging the items comprises sorting the categories of the items in the dataset by performing a query on the second database using the ordinal positions as a first sort key.

10. A method according to claim 9 comprising performing a first sort operation sorting those items in the dataset belonging to a first number of the categories represented by items in the dataset, the first number of categories having sequential ordinal positions within the dataset and including fewer than all of the categories represented by items in the dataset.

11. A method according to claim 10 comprising subsequently, in response to a user input, performing a second sort operation sorting some or all of the items in the dataset not sorted by the first sort operation.

12. A method according to claim 8 comprising classifying the items in the first database into the categories by including in each category items having a set of values of one or more attributes that satisfies a rule for inclusion in the category.

13. A method according to claim 8 wherein using the keys to look up the ordinal positions of the categories associated with the items comprises obtaining from each of the keys an identifier uniquely identifying a category to which the corresponding item belongs.

14. A method according to claim 13 wherein obtaining the identifiers from the keys comprises shifting the keys by a predetermined number of bits.

15. A method according to claim 1 wherein the key for each item comprises information sufficient to identify the category of the hierarchy to which the item belongs.

16. A method according to claim 1 wherein the key comprises a first part corresponding to a category of the hierarchy and a second part comprising a sequence number such that no two of the items have identical keys.

17. A method according to claim 1 wherein using the keys to look up the ordinal positions of the categories associated with the items comprises using the keys as indices into a first table maintained entirely in a memory accessible to a data processor and retrieving the ordinal positions from the first table.

18. A method according to claim 1 wherein two or more of the items are associated with a same one of the categories and the method comprises sorting the two or more of the items in order of a value of an attribute of the two or more items.

19. A program product comprising a medium bearing computer-readable instructions which, when executed by a data processor in a computer system, cause the computer system to execute a method comprising:
executing a search query on the database and retrieving items of a result dataset in order according to categories assigned to the items, each item comprising a key associating the item with a corresponding category in a hierarchy comprising a plurality of categories, each of the categories having a predetermined ordinal position in the hierarchy;
arranging the items of the dataset in an order of the ordinal positions of the corresponding categories; and,
presenting the dataset in the order by one or more of: displaying;
printing; forwarding to another computer system; and storing in a memory; at least a portion of the sorted dataset.

20. Apparatus for providing ordered lists of items, the apparatus comprising:
a database storing records representing a multitude of items, each of the items having a plurality of attributes and a unique identifier, each of the items associated with one category in a hierarchy;
a search engine disposed to receive and execute user queries to yield datasets of items, each dataset matching a corresponding one of the user queries, each dataset comprising at least the unique identifiers for the items of the dataset;
a sorting mechanism configured to:
receive the dataset;
use the unique identifiers from the dataset to look up a predetermined ordinal position of one of the categories of the hierarchy corresponding to each item in the dataset; and,
present items from the dataset in an order corresponding to the ordinal positions.

21. Apparatus according to claim 20 wherein the sorting mechanism is configured to retrieve and sort category information associated with each of the categories of the hierarchies represented by one or more items in the dataset.

22. Apparatus according to claim 21 comprising a tertiary sorting mechanism configured to sort items within each of the categories represented in the dataset according to a tertiary sorting criterion.
